(19) United States
(12) Patent Application Publication
(10) Pub. No.: US 2011/0197866 A1
(43) Pub. Date: Aug. 18, 2011

(54) METHOD OF OPERATION OF TWO-STROKE FORCED CYLINDER FILLING ENGINE

(76) Inventor: Evgeny Nikolaevich Zakharov, Moscovskaya oblast (RU)

(21) Appl. No.: 12/998,369

(22) PCT Filed: Oct. 13, 2009
(86) PCT No.: PCT/RU2009/000538

§ 371 Date: Apr. 13, 2011

(30) Foreign Application Priority Data
Oct. 14, 2008 (RU) 2008140443

(51) Int. Cl. F02B 25/22

(52) U.S. Cl. 123/65 EM

(57) ABSTRACT

The invention relates to propulsion engineering, namely to methods of operation of two-stroke engines. The invention makes it possible to increase the power-to-volume ratio of an engine through better cylinder filling and to improve engine performance through the utilization of combustion product energy, while using parts that are easy to produce from inexpensive and readily available materials. The essence of the invention is that a portion of incoming charge is by-passed from a cylinder, during the filling thereof, to an exhaust manifold after the combustion products so that a part of the exhaust manifold is filled. A portion of the combustion products is returned towards the cylinder cavity by fully closing the exhaust manifold with the aid of a valve member, and an incoming charge is pumped from the exhaust manifold to the cylinder cavity via exhaust members by virtue of combustion product energy when the scavenging ports are already closed.

### FIELD OF THE INVENTION

The invention relates to the sphere of engine building, in particular to the methods of operation of two-stroke engines.

### BACKGROUND OF THE INVENTION

As is known there exists a method of operation of a two-stroke engine which consists in evacuation of combustion gases from the piston space via exhaust elements of gas distribution, their release to atmosphere via an exhaust manifold while creating a pressure wave directed towards the cylinder to provide a resistance to movement of the fresh charge being delivered into the piston space and thereby decrease direct ejection of the fresh charge to atmosphere (Ref V. M. Kondratov, Two-Stroke Carburetor Internal Combustion Engines, Moscow, Mashinostroyeniye, 1990, p. 140).

The disadvantages of the known method are low efficiency of returning the charge to the cylinder and creation of a permanent resistance to movement of the fresh charge when the latter forces combustion gases out of the piston space, which impedes solution of the problems of filling the two-stroke engine.

As is known there exists a method of operation of a two-stroke engine which consists in evacuation of combustion gases from the piston space via exhaust elements of gas distribution, their release to atmosphere via an exhaust manifold while shutting off the flow section of exhaust channels to prevent the fresh charge from being directly ejected to atmosphere (Ref. U.S. Patent Application No. 2003/0230258, published Dec. 18, 2003).

The efficiency of this method is higher than that with wave-type exhaust, however, the resistance to movement of combustion gases also increases. Besides, there arise problems of thermal resistance of the slide valve located next to the exhaust ports, as well as problems of providing tightness for its drive.

### SUMMARY OF THE INVENTION

The technical result of the described invention consists in increased power-to-volume ratio of the engine due to improved cylinder filling and creation for the engine of favorable thermal stress conditions, increased performance coefficient due to utilizing the energy of combustion gases while using easy-to-produce parts made of cheap and available materials.

The objective is achieved by the fact that the method of operation of a two-stroke engine with forced cylinder filling consists in that combustion gases are evacuated from the piston space via exhaust elements of gas distribution and released to atmosphere via an exhaust manifold, the piston space is scavenged by and filled with a fresh charge via the scavenging elements of gas distribution, some part of the fresh charge is bypassed, without limitation, from the piston space into the exhaust manifold following combustion gases while filling some part of the exhaust manifold with the fresh charge, then some part of combustion gases is returned back towards the piston space by shutting off the exhaust manifold flow section with a slide valve and reflecting the gas flow therefrom towards the cylinder, the scavenging elements of gas distribution get closed, the fresh charge delivered into the exhaust manifold during the piston space scavenging and filling is forced by means of the reflected gas flow towards the cylinder, the fresh charge is drawn out of the exhaust manifold into the piston space via the opened exhaust elements due to the reflected gas flow energy, the cylinder exhaust elements are shut off, and combustion gases are evacuated from the exhaust manifold.

The claimed objective is also achieved by the fact that combustion gases may be evacuated from the exhaust manifold after shutting off the cylinder exhaust elements by utilizing the energy of repeated gas flow reflection from the closed exhaust element of gas distribution to atmosphere via a preliminary opened slide valve.

The claimed objective is also achieved by the fact that the engine may be pressurized.

The claimed objective is also achieved by the fact that the exhaust and scavenging elements of gas distribution may be made as separate tiers of ports in the cylinder wall which are shut off and opened by the edge of the piston reciprocating inside the cylinder, where a circular channel is formed around the tier of exhaust ports, which is communicated with the exhaust manifold.

### BRIEF DESCRIPTION OF THE DRAWINGS

FIG. 1 shows the drawing of a two-stroke engine with its operating elements at the instance of injection beginning;

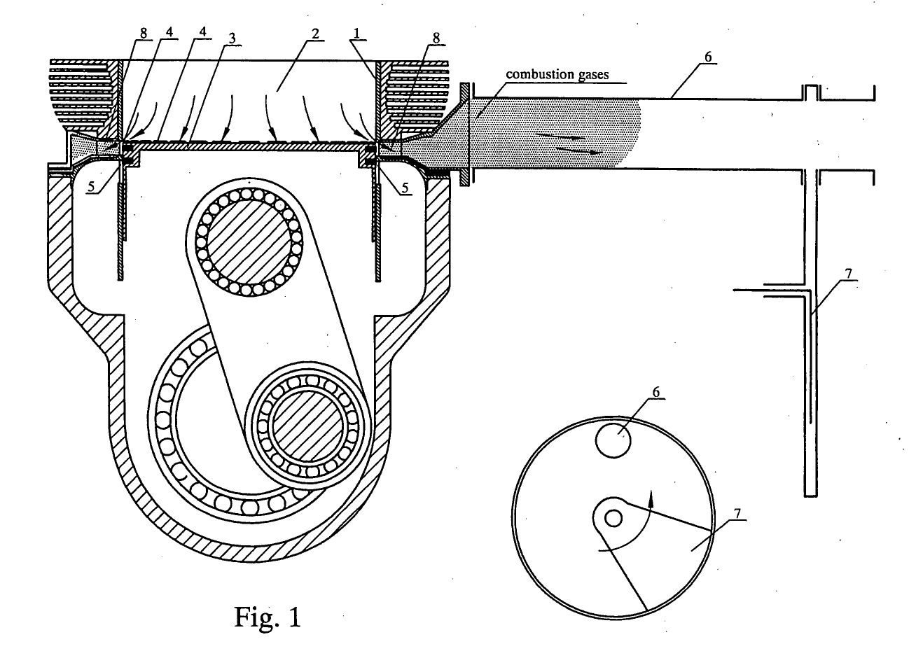

FIG. 2 shows the same, at the instance of scavenging beginning;

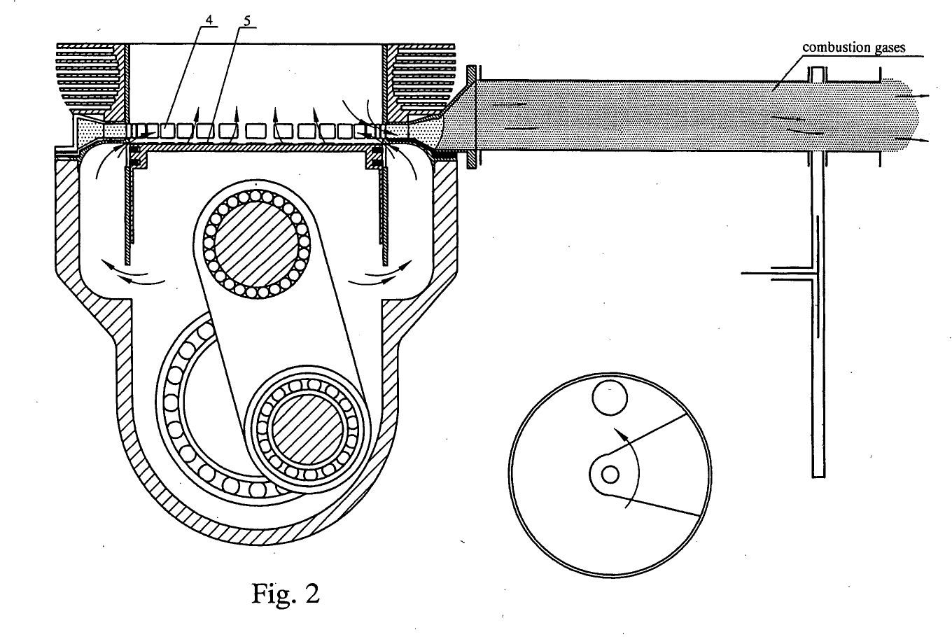

FIG. 3 shows the same, at the instance of filling some part of the exhaust manifold;

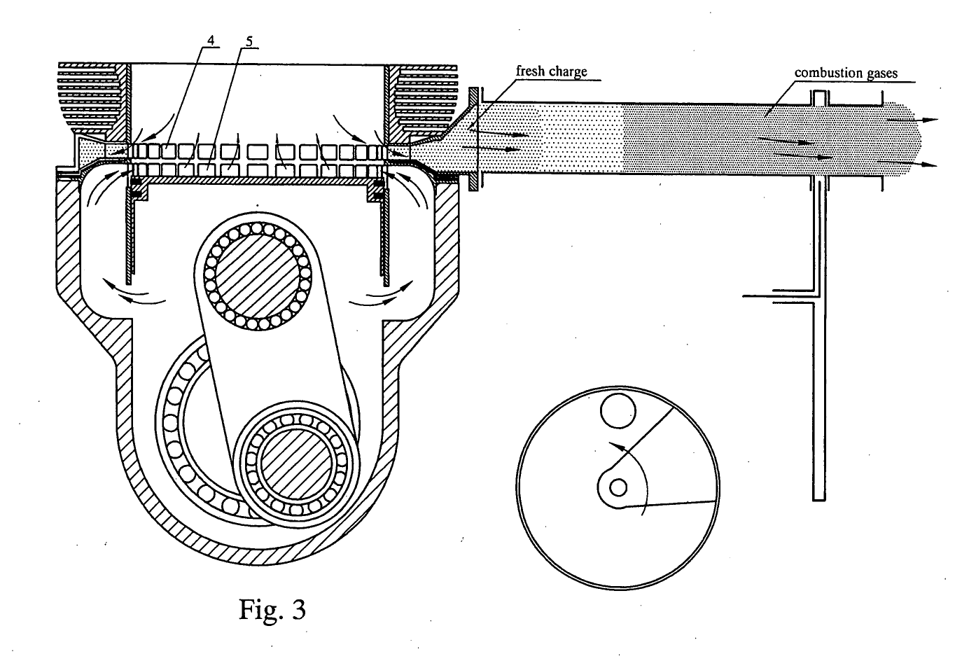

FIG. 4 shows the same, at the instance of the slide valve shut-off;

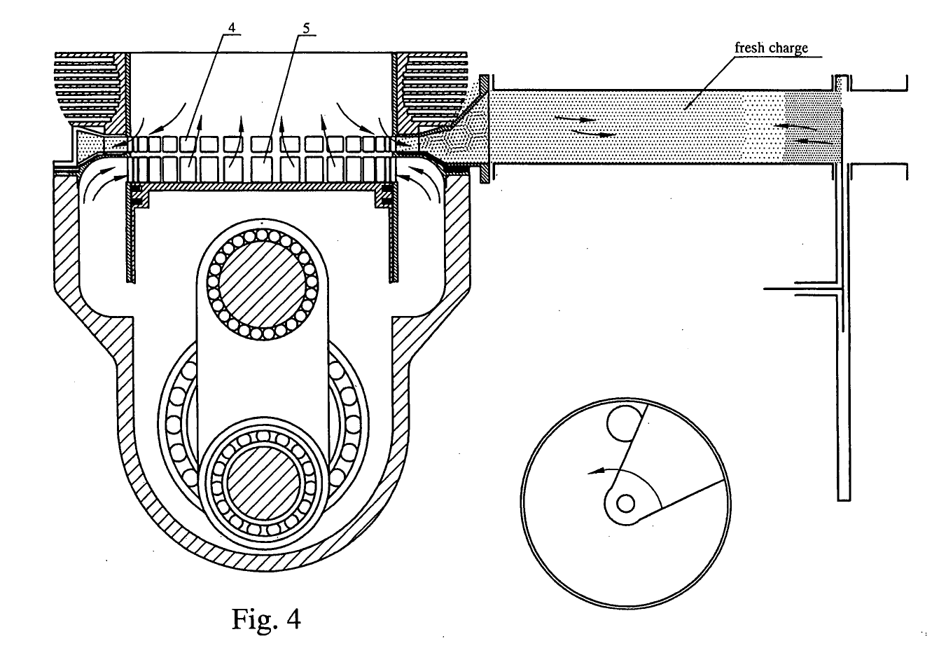

FIG. 5 shows the same, at the instance of drawing the fresh charge out of the exhaust manifold into the piston space;

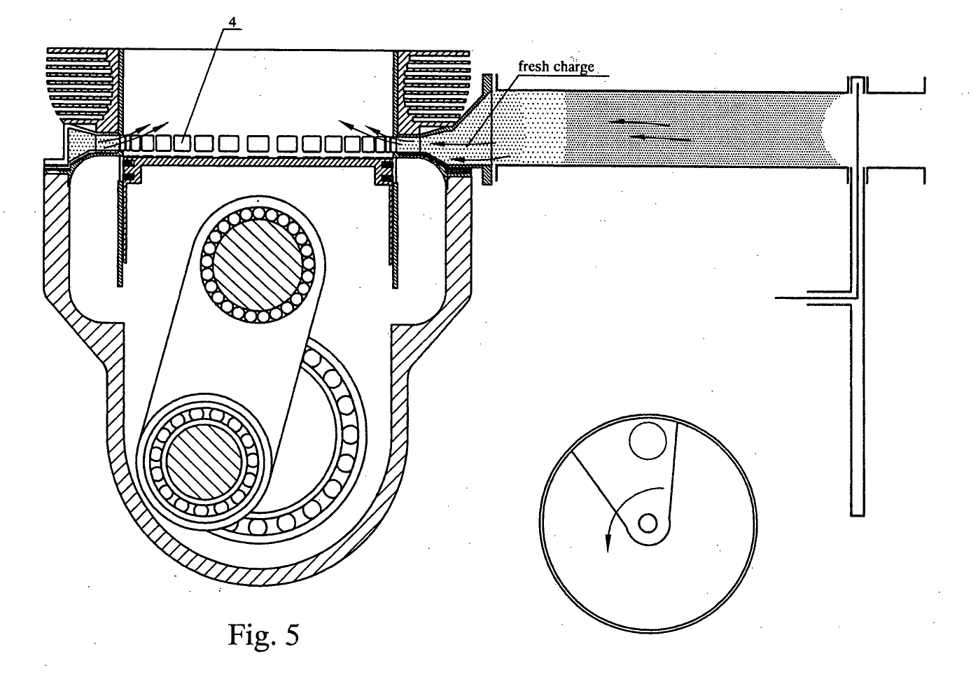

FIG. 6 shows the same, after the piston shuts off the exhaust elements.

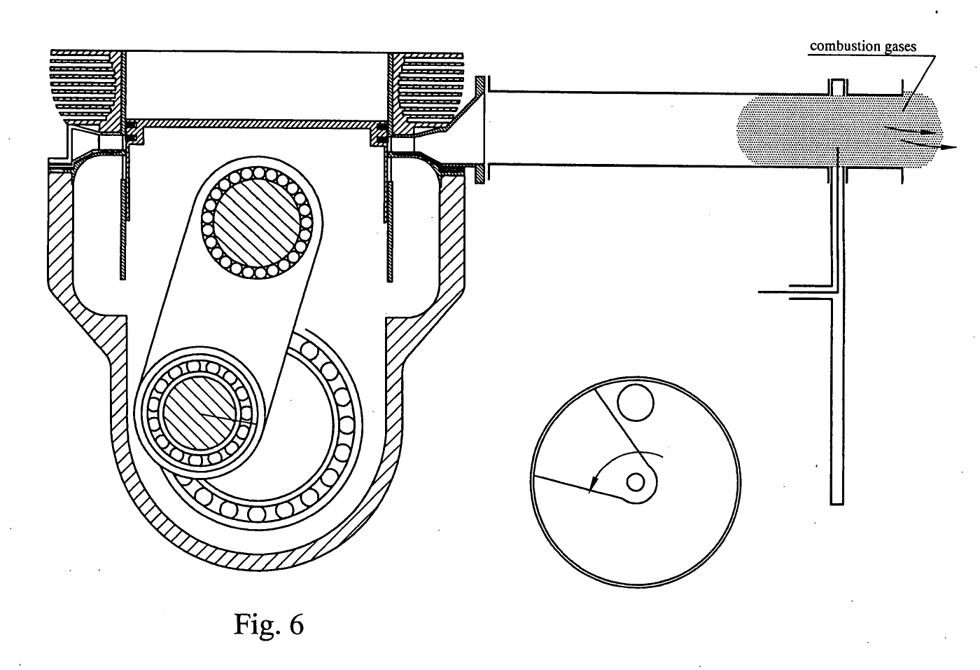

### THE BEST EMBODIMENT OF THE INVENTION

The declared method is implemented with use of an engine comprising cylinder 1 with work space 2, piston 3 located inside cylinder 1 and capable of shutting off exhaust 4 and scavenging 5 ports with its edge. Space 2 of cylinder 1 communicates with atmosphere by means of exhaust ports 4 and exhaust manifold 6. Installed at the outlet of manifold 6 is slide valve 7, capable of shutting off the flow section of manifold 6 and isolating it from atmosphere. Slide valve 7 is synchronized with rotation of the engine crankshaft (not shown) and may be installed directly on the crankshaft. When flow-type scavenging is used, circular channel 8 is formed around the tier of exhaust ports 4 and is connected with exhaust manifold 6.

The described method of operation is implemented as follows. At the end of combustion gas expansion, exhaust ports 4 are opened by the edge of piston 3 in cylinder 1. The combustion gases are freely exhausted to atmosphere via exhaust manifold 6, then scavenging ports 5 are opened, a fresh charge is supplied into space 2 of cylinder which fills it in and forces out the remaining combustion gases. The gas flow rate during the open exhaust in a two-stroke engine is much higher than that in a four-stroke engine due to a high rate of the port section increase, therefore the phenomenon of pressure-drop occurs both in the piston space and in the exhaust manifold. Due to this phenomenon, called the Kadenacy effect, the fresh charge during a two-stroke engine cylinder filling is usually drawn by the combustion gases into the exhaust manifold. Therewith, the higher is the exhaust section increase rate, the higher is the pressure-drop. On the one hand, the engine should evacuate combustion gases from the cylinder as quickly as possible, while on the other hand, the higher is the evacuation rate, the higher are direct losses of the fresh charge during scavenging. This is another reason why the design of a classic two-stroke engine is the result of a selection of compromise engineering solutions which altogether deteriorate the engine work process. The described engine does nothing to increase the resistance to movement of the gases towards exhaust ports 4; on the contrary, it creates conditions for fast filling of both space 2 of the cylinder and some part of exhaust manifold 6 downstream of exhaust ports 4. After that the flow section of exhaust manifold 6 is shut off by slide valve 7 for a relatively short time period, after the greatest part of combustion gases has passed therethrough. The gases hit an obstacle, change direction of their movement and return back to cylinder 1 while pushing in front of them the fresh charge drawn into exhaust manifold 6 by the combustion gases. By the time when the fresh charge is drawn from exhaust manifold 6 into space 2, scavenging ports 5 will already be closed by piston 3 moving towards TDC, therefore the charge being drawn into cylinder 1 will remain in its space 2. After the piston shuts off exhaust ports 4, the fresh charge is compressed and then combusted. Having drawn in the charge, the combustion gases hit against the side wall of piston 3 or another shut-off element, which has closed exhaust ports 4, and leave exhaust manifold 6 via the section opened by the moment by slide valve 7.

Not only does the described method prevent losses in the fresh charge by returning it to the cylinder, but pressurizes the piston space as well. It is known that pressurization is only possible if the fresh charge is shut off to prevent its escape from the cylinder. In two-stroke engines such phenomenon is only possible when asymmetric gas distribution phases are used, for example, with valve systems (with a low forcing degree limit). Two-stroke slot-type engines, with all their advantages, have always been facing the problem of charge losses and resulting unpressurizability.

The described method makes it possible to deliver a fresh charge being excessive as compared to the piston space without the risk of losing it. Moreover, utilization of the combustion gas energy, in addition to returning the fresh charge to the cylinder, returns to the operating cycle some part of the combustion gas energy, thus substantially increasing the engine efficiency. Prototype tests on engine test benches have demonstrated a record-breaking specific efficiency, which is unachievable at present even for four-stroke engines.

It should be noted here that a fresh charge is delivered by a supercharger into the piston space with a minimum resistance and with a minimum degree of pressure increase, which reduces the supercharger driving expenditures. Therewith, not only is the piston space filled, but the adjoining space of the exhaust manifold as well, and compression of the charge during its subsequent delivery into the piston space is provided by the combustion gases which have already performed their work in the cylinder. The described phenomena are similar to those occurring in the known wave-type pressure exchangers.

It should also be noted, that shutting off exhaust manifold 6 after the hottest part of exhaust gases has passed therethrough provides a possibility to use available cheap materials for the slide valve manufacture. In prototypes, a leaf made of steel 65G fitted with a certain clearance relative to the slide valve walls was used as a shut-off element, i.e. no additional energy expenditures were required for driving it.

To enhance the effect when implementing the described method of operation, flow-type scavenging should be used, when exhaust is provided simultaneously via the whole tier of ports 4 arranged along the whole circumference of cylinder 1. In this case, cylinder space 2 is emptied practically instantaneously, which is accompanied by occurrence of a perceptible Kadenacy effect. If no means for returning the charge to the cylinder are used, such engine will feature an extremely low power-to-volume ratio and an increased specific fuel rate. However, such organization of scavenging is most optimal within the framework of this method, as it makes it possible to reach the maximum evacuation rate of combustion gases from the cylinder immediately after opening the exhaust ports and to obtain the maximum section of the same ports when drawing the charge back into the cylinder out of the exhaust manifold, with the scavenging ports closed by that time. Besides, this type of scavenging provides for creation of more favorable engine thermal stress conditions due to a more uniform thermal load around the cylinder circumference.

Besides, delivery of a relatively cold fresh charge via the exhaust ports provides cooling for the piston and exhaust port edges heated during exhaust, which reduces the engine thermal stress as a whole and makes it possible to increase the amount of charge combusted during one cycle. It is believed that the two-stroke cycle is more intensive due to the frequency of combustion strokes as compared to the four-stroke engine. However, it appears that the high thermal stress in the two-stroke engine results from a lower flow rate of the fresh charge through the piston space (the volumetric efficiency of a two-stroke engine with crankcase scavenging is equal to about 0.5) and from local overheating of the piston and exhaust port edges due to a higher flow rate of hot gases at the instance of exhaust beginning. It also appears that the most unfavorable factor for an engine is not the heating of port edges itself, but the resulting cylinder warping due to non-uniformity of such heating along its circumference, which in its turn leads to loss of the work space tightness. In this context, such phenomenon as a skin effect should be noted: the quicker the heat imparted to a body surface is removed therefrom, the greater is the amount of this heat that can be removed. In two-stroke engines, the contact between the heated parts and cold fresh charge begins with twice as less delay as in four-stroke ones, and the capability of cooling the heated edges of the piston and exhaust ports, provided additionally by the declared method, will make it possible to obtain the limit power-to-volume ratios, in particular in the two-stroke engine. At the same time, the amount of the fresh charge passed through the exhaust ports during the engine pressurization will make it possible to compensate for the growing thermal stress inevitably occurring due to the increased amount of charge combusted in the cylinder during one cycle. Therewith, it should be noted that the limit power-to-volume ratio in the described engine is determined solely by the limit mechanical capabilities of the crank-and-rod mechanism converting piston reciprocations.

### INDUSTRIAL APPLICABILITY

Thus, the claimed invention provides a comprehensive solution for the problem of the work process efficiency in two-stroke engines, ensures increased engine performance coefficient and power-to-volume ratio. Besides, realization of this method extends the possibilities for employment of various types of pressurization in two-stroke engines for the purpose of achieving higher power-to-volume ratios as compared to four-stroke engines.

1. A method of operation of a two-stroke engine with forced cylinder filling consisting in that combustion gases are evacuated from the piston space via exhaust elements of gas distribution and released to atmosphere via an exhaust manifold, the piston space is scavenged by and filled with a fresh charge via the scavenging elements of gas distribution, some part of the fresh charge is bypassed, without limitation, from the piston space into the exhaust manifold following combustion gases while filling some part of the exhaust manifold with the fresh charge, then some part of combustion gases is returned back towards the piston space by shutting off the exhaust manifold flow section with a slide valve and reflecting the gas flow therefrom towards the cylinder, the scavenging elements of gas distribution get closed, the fresh charge delivered into the exhaust manifold during the piston space scavenging and filling is forced by means of the reflected gas flow towards the cylinder, the fresh charge is drawn out of the exhaust manifold into the piston space via the opened exhaust elements due to the reflected gas flow energy, the cylinder exhaust elements are shut off, and combustion gases are evacuated from the exhaust manifold.

2. A method of claim 1, wherein combustion gases are evacuated from the exhaust manifold after shutting off the cylinder exhaust elements by utilizing the energy of repeated gas flow reflection from the closed exhaust element of gas distribution to atmosphere via a preliminary opened slide valve.

3. A method of claim 1, wherein the engine is pressurized.

4. A method of claim 1, wherein the exhaust and scavenging elements of gas distribution are made as separate tiers of ports in the cylinder wall which are shut off and opened by the edge of the piston reciprocating inside the cylinder, where a circular channel is formed around the tier of exhaust ports, which is communicated with the exhaust manifold.
